(19) United States
(12) Patent Application Publication
(10) Pub. No.: US 2025/0140892 A1
(43) Pub. Date: May 1, 2025

(54) BATTERY, BATTERY MODULE AND METHOD OF PRODUCING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(73) Assignee: TOYOTA JIDOSHA KABUSHIKI KAISHA, Toyota-shi (JP)

(21) Appl. No.: 18/930,146

(22) Filed: Oct. 29, 2024

(30) Foreign Application Priority Data
Oct. 31, 2023 (JP) 2023-187210

(51) Int. Cl. H01M 10/04; H01M 50/609

(52) U.S. Cl. CPC H01M 10/0468; H01M 50/609

(57) ABSTRACT

A battery 10, including an electrode body 30 that includes an electrode and a separator, and an exterior body 20A, 20B that is disposed around the electrode body 30, the battery being restrained by a restraining member, the electrode body 30 having a bonded portion at which the electrode and the separator are bonded to each other, and a non-bonded portion at which the electrode and the separator are not bonded to each other, and at least a part of the non-bonded portion of the electrode body 30 matching a portion of the battery restrained by the restraining member 40.

### CROSS-REFERENCE TO RELATED APPLICATION

This application is based on and claims priority under 35 USC 119 from Japanese Patent Application No. 2023-187210 filed on Oct. 31, 2023, the disclosure of which is incorporated by reference herein.

### BACKGROUND

### Technical Field

The present disclosure relates to a battery, a battery module and a method of producing a battery.

### Related Art

Lithium ion secondary batteries are typically produced by injecting an electrolytic solution into an exterior body in which an electrode body, which includes an electrode and a separator, is accommodated. In order to secure close contact between an electrode and a separator, and maintain a constant distance between the electrodes, an electrode and a separator are bonded to each other in some cases.

Meanwhile, bonding an electrode and a separator to each other may cause difficulty in permeation of an electrolytic solution into the electrode body, and improvement in efficiency of the liquid injection operation is desired.

As a method for improving the permeability of an electrolytic solution into an electrode body, for example, Japanese Patent Application Laid-Open (JP-A) No. 2002-15773 proposes a method of providing, when bonding an electrode and a separator which constitute an electrode body, providing a portion at which the electrode and the separator are not bonded to each other.

The battery produced by the method described in JP-A No. 2002-15773 may fail to maintain a predetermined distance between electrodes at a position at which an electrode and a separator are not bonded to each other.

### SUMMARY

In view of the foregoing, an object of an embodiment of the present disclosure is to provide a battery that exhibits excellent permeability of an electrode body with respect to an electrolytic solution and maintains a favorable state of distance between electrodes; a battery module including the battery; and a method of producing the battery.

The means for solving the above-described problem include the following embodiments.

<1> A battery, including an electrode body that includes an electrode and a separator, and an exterior body that is disposed around the electrode body, the battery being restrained by a restraining member,

the electrode body having a bonded portion at which the electrode and the separator are bonded to each other, and a non-bonded portion at which the electrode and the separator are not bonded to each other, and at least a part of the non-bonded portion of the electrode body matching a portion of

the battery restrained by the restraining member.

<2> The battery according to <1>, wherein an entirety of the non-bonded portion of the electrode body matches the portion of the battery restrained by the restraining member.

<3> The battery according to <1> or <2>, wherein the non-bonded portion of the electrode body completely matches the portion of the battery restrained by the restraining member.

<4> A battery module, including the battery according to any one of <1> to <3>.

<5> A method of producing the battery according to any one of <1> to <3>, the method including:

preparing an electrode body, the electrode body having a bonded portion at which an electrode and a separator are bonded to each other and a non-bonded portion at which the electrode and the separator are not bonded to each other;

disposing an exterior body around the electrode body;

supplying an electrolytic solution to an internal space of the exterior body; and

disposing a restraining member around the exterior body.

<6> A method of producing the battery according to any one of <1> to <3>, the method including:

preparing an electrode body, the electrode body having a bonded portion at which an electrode and a separator are bonded to each other and a non-bonded portion at which the electrode and the separator are not bonded to each other;

disposing a restraining member around the electrode body;

disposing an exterior body around the electrode body around which the restraining member is disposed; and

supplying an electrolytic solution to an internal space of the exterior body.

According to an embodiment of the present disclosure, it is possible to provide a battery that exhibits excellent permeability of an electrode body with respect to an electrolytic solution and maintains a favorable state of distance between electrodes; a battery module including the battery; and a method of producing the battery.

### BRIEF DESCRIPTION OF THE DRAWINGS

Exemplary embodiments of the present disclosure will be described in detail based on the following figures, wherein:

FIG. 1 is a sectional view schematically illustrating an example of a configuration of a battery;

FIG. 2 is a sectional view schematically illustrating an example of a configuration of a battery;

FIG. 3 is a sectional view schematically illustrating an example of a configuration of a battery;

FIG. 4 is a graph illustrating a result of evaluation of permeability of an electrode body;

FIG. 5 is a diagram schematically illustrating an example of application of a battery to an electric vehicle;

FIG. 6 is a diagram schematically illustrating an example of a configuration of a battery module;

FIG. 7 is a diagram schematically illustrating an example of a configuration of a battery module; and

FIG. 8 is a diagram schematically illustrating an example of a configuration of a battery cell included in a battery module.

### DETAILED DESCRIPTION

In the present disclosure, a numerical range indicated by using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only independent steps, and even in a case in which a step cannot be clearly distinguished from another step, it is encompassed by this term as long as the intended purpose of the step is achieved.

In a case in which an exemplary embodiment is explained in the present disclosure with reference to the drawings, the configuration of the exemplary embodiment is not limited to the configuration illustrated in the drawings. Furthermore, sizes of members in the respective drawings are conceptual, and relative relationships between sizes of members are not limited thereto.

### Battery

A first embodiment of the present disclosure is a battery, including an electrode body that includes an electrode and a separator, and an exterior body that is disposed around the electrode body, the battery being restrained by a restraining member,

the electrode body having a bonded portion at which the electrode and the separator are bonded to each other, and a non-bonded portion at which the electrode and the separator are not bonded to each other, and

at least a part of the non-bonded portion of the electrode body matching a portion of the battery restrained by the restraining member.

In the battery of the present disclosure, the electrode body has a bonded portion at which the electrode and the separator are bonded to each other, and a non-bonded portion at which the electrode and the separator are not bonded to each other. Therefore, the electrode body ensures favorable permeability with respect to an electrolytic solution, as compared with an electrode body in which an electrode and a separator are completely bonded to each other.

Further, in the battery of the present disclosure, at least a part of the non-bonded portion of the electrode body matches a portion of the battery restrained by the restraining member, i.e., at least a part of the non-bonded portion of the electrode body is restrained by the restraining member. Therefore, a favorable state of distance between the electrodes is maintained at at least a part of the non-bonded portion.

In the following, the electrode body, the exterior body and the restraining member included in the battery of the present disclosure are explained.

### Electrode Body

The type of the electrode body is not particularly limited, and may be selected depending on the scale or the purpose of the battery.

For example, a layered body including electrodes (negative electrodes and positive electrodes) and separators that are disposed between the electrodes may be used as the electrode body.

The number of the electrodes and the separators included in the electrode body is not particularly limited, and may be selected depending on the scale or the purpose of the battery.

The size of the battery is not particularly limited, and may be selected depending on the scale or the purpose of the battery. For example, the area of the principal surface of the electrode body may be selected from a range of from 50 cm² to 50000 cm², and the thickness of the electrode body may be selected from a range of from 5 mm to 50 mm.

For example, a structure in which a layer containing an electrode active material is formed at the one face or both faces of a current collector may be used as the electrode.

For example, a microporous film composed of a resin such as polyethylene may be used as the separator.

The electrode body has a bonded portion at which the electrode and the separator are bonded to each other, and a non-bonded portion at which the electrode and the separator are not bonded to each other.

The bonding of the electrode and the separator may be performed by, for example, disposing an adhesive between the electrode and the separator and heating the same.

Examples of the adhesive include polyvinylidene fluoride (PVdF) and acrylic resin that melts by heat.

When the electrode body includes plural electrodes and plural separators, the electrode body may have a configuration in which, at the same position, some of the electrodes are bonded to the separator and some of the electrodes are not bonded to the separator. Alternatively, the electrode body may have a configuration in which, at the same position, all of the electrodes are bonded to the separator.

In the present disclosure, a portion at which at least one of the electrodes is bonded to the separator is regarded as the “bonded portion”, and a portion at which none of the electrodes is bonded to the separator is regarded as the “non-bonded portion”.

From the viewpoint of ensuring the permeability with respect to an electrolytic solution, the proportion of the non-bonded portion with respect to the area of the principal surface of the electrode body is preferably 1% or more, more preferably 5% or more, further preferably 10% or more.

From the viewpoint of ensuring a favorable distance between the electrodes, the proportion of the non-bonded portion with respect to the area of the principal surface of the electrode body is preferably 30% or less, more preferably 25% or less, further preferably 20% or less.

When the non-bonded portion is provided at the electrode body in a patterned manner, the pattern may be in any form. For example, the non-bonded portion may have a striped pattern, a dotted pattern, a grid pattern, or a combination thereof.

Examples of the method for providing the non-bonded portion at the electrode body in a patterned manner include a method of pressurizing the electrode body with a roll having a recessed portion at a surface thereof. According to the method, it is possible to provide the electrode body with the non-bonded portion having a pattern corresponding to the shape of the recessed portion of the roll.

In the battery of the present disclosure, at least a part of the non-bonded portion of the electrode body matches a portion of the battery restrained by the restraining member.

In the present disclosure, the portion of the battery restrained by the restraining member may be referred to as the “restrained portion”.

From the viewpoint of ensuring a favorable distance between the electrodes at the non-bonded portion of the electrode body, 50% or more, 60% or more, 70% or more, 80% or more, 90% or more, or 100% (i.e., an entirety of the non-bonded portion) of the non-bonded portion of the electrode body preferably matches the restrained portion of the battery.

From the viewpoint of ensuring a favorable distance between the electrodes at the non-bonded portion of the electrode body, the non-bonded portion of the electrode body preferably completely matches the restrained portion of the battery.

In other words, the electrode body preferably has a configuration in which an entirety of the non-bonded portion matches the restrained portion of the battery, and none of the non-bonded portion is located at a portion that is not the restrained portion of the battery.

### Exterior Body

The type of the exterior body is not particularly limited as long as it can accommodate the electrode body.

A layered body including a metal layer containing metal such as aluminum and a heat seal layer (i.e., a laminate film) may be used as the exterior body. Therefore, the battery of the present disclosure may be a battery using a laminate film as an exterior body (i.e., a laminate battery).

The exterior body may be composed of a single member, or may be composed of two or more members. For example, when the exterior body is a sheet-shaped object, the exterior body may be composed of a single sheet-shaped object, or may be composed of two sheet-shaped objects.

### Restraining Member

The type of the restraining member is not particularly limited, as long as it can restrain the battery.

From the viewpoint of case of disposing the restraining member around the exterior body, a tape is preferably used as the restraining member. The width of the tape is not particularly limited, and may be selected from a range of from 5 mm to 100 mm.

The restraining member may have thermal contractility. When the restraining member has thermal contractility, the restraining member disposed around the exterior body shrinks by heat, and the battery is compressed by the restraining member. The thermal source for the heating may be heat generated by the action of charge and discharge of the battery, or may be heat applied by a heater or the like during the production of the battery.

Exemplary materials for the restraining member having thermal contractility include polyamide (nylon), polypropylene, polyester, polyethylene, polyethylene phthalate and polystyrene.

In the battery of the present disclosure, there is no restriction on the manner of locating the portion restrained by the restraining member. For example, the portion restrained by the restraining member may be located separately at from 1 to 10 sites at the outer periphery of the battery or the electrode body. Alternatively, the portion restrained by the restraining member may be located so as to cover the entirety of the battery or the electrode body.

### Battery Module

A second embodiment of the present disclosure is a battery module including the foregoing battery.

In the present disclosure, the battery module refers to an object including a group of plural batteries (cells). The number of the batteries included in a single battery module is not particularly limited, and may be from 5 to 30, for example.

There is no restriction on the manner of restraining the batteries included in the battery module by the restraining member. For example, the restraining member may be disposed at at least one selected from the outer periphery of the group of plural batteries included in the battery module; the outer periphery of each of the batteries included in the group; or the outer periphery of the electrode body in each of the batteries included in the group.

### Method of Producing Battery

A third embodiment of the present disclosure is a method of producing the battery of the foregoing first embodiment, the method including:

preparing an electrode body, the electrode body having a bonded portion at which an electrode and a separator are bonded to each other and a non-bonded portion at which the electrode and the separator are not bonded to each other;

disposing an exterior body around the electrode body;

supplying an electrolytic solution to an internal space of the exterior body; and

disposing a restraining member around the exterior body.

In the present embodiment, there is no restriction on the method of preparing an electrode body having a bonded portion at which an electrode and a separator are bonded to each other and a non-bonded portion at which the electrode and the separator are not bonded to each other, and the electrode body may be prepared by a known method.

For example, the electrode body may be prepared by disposing an adhesive at a predetermined portion between the electrode and the separator, and bonding the electrode and the separator by applying heat and pressure as necessary.

In the present embodiment, there is no restriction on the method of disposing an exterior body around the electrode body. For example, when a laminate film is used as the exterior body, the exterior body may be disposed around the electrode body by the following Method 1 or Method 2.

Method 1: a method of, in a state in which the electrode body is disposed between one laminate film that has been folded in half or between two laminate films that have been superposed, joining the laminate film (or laminate films) at a periphery of the electrode body by heat scaling

Method 2: a method of joining a periphery of one laminate film that has been folded in half or two laminate films that have been superposed by heat sealing, and disposing the electrode body at a space surrounded by the joined portion of the laminate film (or laminate films)

As necessary, a recessed portion for accommodating the electrode body may be formed to the laminate film by embossing.

In the present embodiment, the method for supplying an electrolytic solution to the internal space of the exterior body is not particularly limited, and may be performed by a known method.

The supply of the electrolytic solution may be performed in such a manner that the opening (an injection port for the electrolytic solution) of the exterior body, in which the electrode body has been disposed, is positioned at the upper side in a direction of gravitational force.

From the viewpoint of increasing the permeability of the electrode body with respect to an electrolytic solution, the internal space of the exterior body may be depressurized prior to supplying the electrolytic solution.

In the present embodiment, the electrode body is provided with the non-bonded portion at which the electrode and the separator are not bonded to each other. Therefore, it is possible to depressurize the internal space of the exterior body smoothly as compared with the case in which the electrode body is not provided with the non-bonded portion.

The electrolytic solution may be supplied to the internal space of the exterior body in a single process or in multiple processes.

The method of sealing the opening of the exterior body after supplying the electrolytic solution is not particularly limited, and may be performed by a known method.

In the present embodiment, the method of disposing the restraining member around the exterior body is not particularly limited, and may be performed by a known method.

The position at which the restraining member is disposed is not particularly limited, as long as the position matches at least a part of the non-bonded portion of the electrode body at which the electrode and the separator are not bonded to each other.

In the present embodiment, the order of performing the process of supplying the electrolytic solution to the internal space of the exterior body and the process of disposing the restraining member around the exterior body is not particularly limited, and either one of the processes may be performed in advance.

A fourth embodiment of the present disclosure is a method of producing the battery according to the foregoing first embodiment, the method including:

preparing an electrode body, the electrode body having a bonded portion at which an electrode and a separator are bonded to each other and a non-bonded portion at which the electrode and the separator are not bonded to each other;

disposing a restraining member around the electrode body;

disposing an exterior body around the electrode body around which the restraining member is disposed; and

supplying an electrolytic solution to an internal space of the exterior body.

The method of the fourth embodiment may be performed in the same manner with the method of the third embodiment, except that the restraining member is disposed around the electrode body instead of disposing the restraining member around the exterior body.

In the method according to the fourth embodiment, a further restraining member may be disposed around the exterior body, in addition to the restraining member disposed around the electrode body.

The battery of the present disclosure is explained by referring to the drawings.

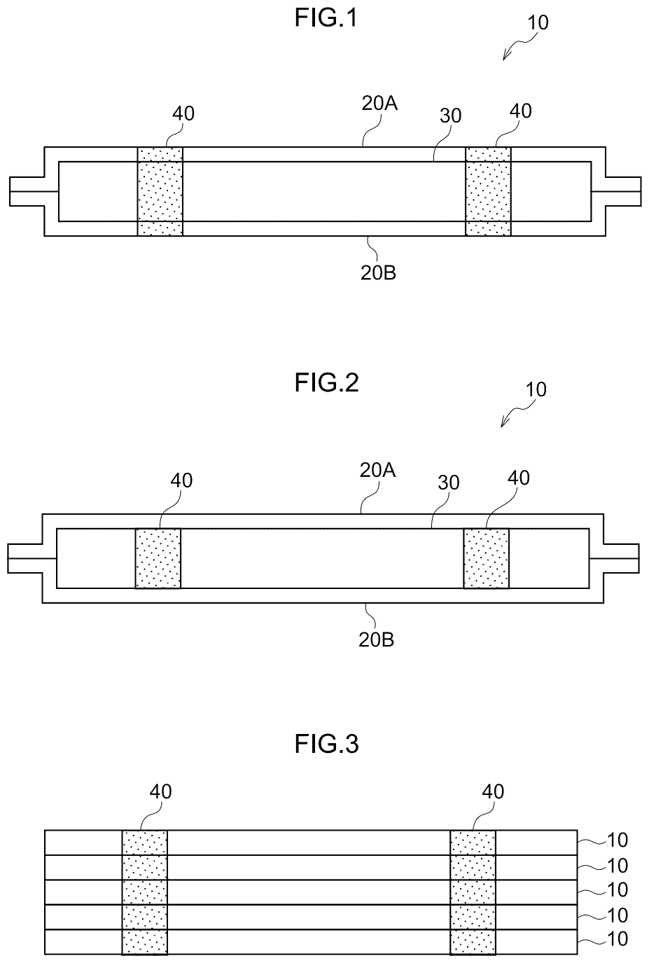

FIG. 1 is a sectional view schematically illustrating an example of the battery of the present disclosure.

The battery 10 shown in FIG. 1 has the first exterior body 20A, the second exterior body 20B, and the electrode body 30 that is disposed between the first exterior body 20A and the second exterior body 20B.

The first exterior body 20A and the second exterior body 20B are joined to each other at a portion corresponding to the periphery of the electrode body 30, and constitute an exterior body in which the electrode body 30 is accommodated.

The battery 10 has the restrained portion 40, which is restrained by a restraining member (not shown), at the outer periphery of the battery 10 (i.e., outside the exterior body).

The battery 10 may be restrained by a further restraining member that is disposed at the outer periphery of the electrode body 30 (i.e., inside the exterior body).

While not shown in the drawing, the electrode body 30 has a bonded portion at which an electrode and a separator are bonded to each other and a non-bonded portion at which an electrode and a separator are not bonded to each other, and at least a part of the non-bonded portion is located at the restrained portion 40.

FIG. 2 is a sectional view schematically illustrating an example of the battery of the present disclosure.

The battery 10 shown in FIG. 2 has the same configuration with the battery 10 shown in FIG. 1, except that the restrained portion 40 is restrained by a restraining member disposed at the outer periphery of the electrode body 30 (i.e., inside the exterior body).

FIG. 3 is a sectional view schematically illustrating an embodiment of the battery of the present disclosure in which a group of plural batteries 10 are restrained by the restraining member.

In the group of the batteries 10 shown in FIG. 3, the restrained portion 40 may be restrained by a restraining member disposed at the outer periphery of the group of the batteries 10; restrained by a restraining member that is disposed at the outer periphery of each of the batteries 10; restrained by a restraining member disposed at the outer periphery of the electrode body included in each of the batteries 10; or restrained by a combination of the foregoing restraining members.

### Evaluation of Permeability of Electrode Body

The permeability with respect to an electrolytic solution was compared between an electrode body in which electrodes and separators are bonded to each other and an electrode body in which electrodes and separators are not bonded to each other.

Specifically, an electrode body having a layered structure composed of seven positive-electrode layers and eight negative-electrode layers was prepared using a separator having PVdF adhesive layers at both faces thereof (bonded) or a separator having an Al₂O₃ heat-resistant layer at one face thereof (non-bonded). The dimension of the separator was 144.9 cm×80.7 cm

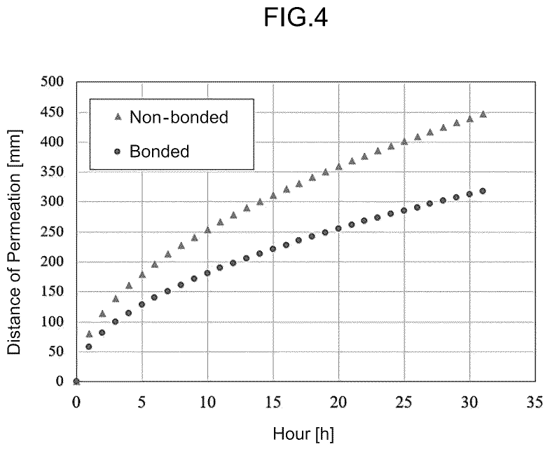

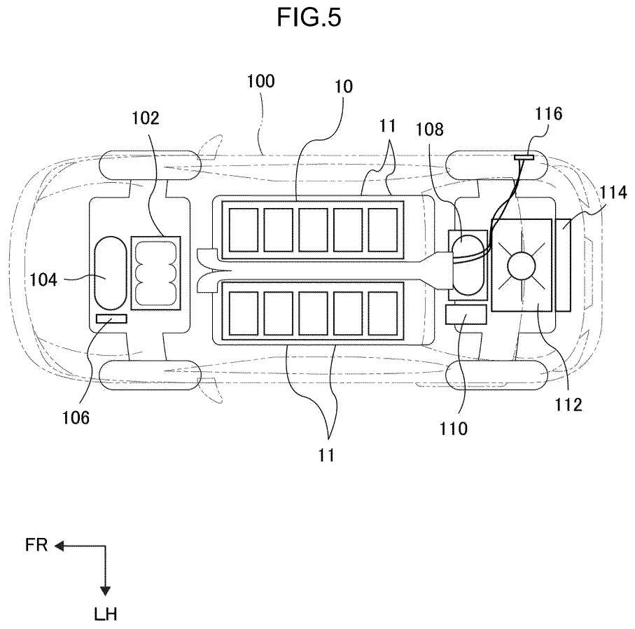

A laminate battery (5 Ah) was prepared using the electrode body and an electrolytic solution was injected thereto. A distance of permeation of the electrolytic solution was recorded hourly since the injection of the electrolytic solution using the CT images of the laminate battery. The results are shown in FIG. 4.

As shown in FIG. 4, the distance of permeation of the electrolytic solution per hour was greater in the electrode body in which electrodes and separators are not bonded to each other (non-bonded) than the electrode body in which electrodes and separators are bonded to each other (bonded), indicating a superior permeation of the electrode body (bonded) to the electrode body (non-bonded).

### Application Examples of Battery

The battery of the present disclosure may be mounted at an electric vehicle. Hereinafter, an example in which the battery of the present disclosure is applied to an electric vehicle will be explained with reference to the drawings. In the following explanation, a “battery cell 20” corresponds to the battery of the present disclosure.

FIG. 5 is a schematic plan view illustrating a main part of a vehicle 100 to which a battery pack 10 according to an embodiment has been applied. As shown in FIG. 5, the vehicle 100 is an electric vehicle (battery electric vehicle (BEV)) in which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are disposed further toward a vehicle front side than the battery pack 10. Further, a motor 108, a gear box 110, an inverter 112, and a charger 114 are disposed further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

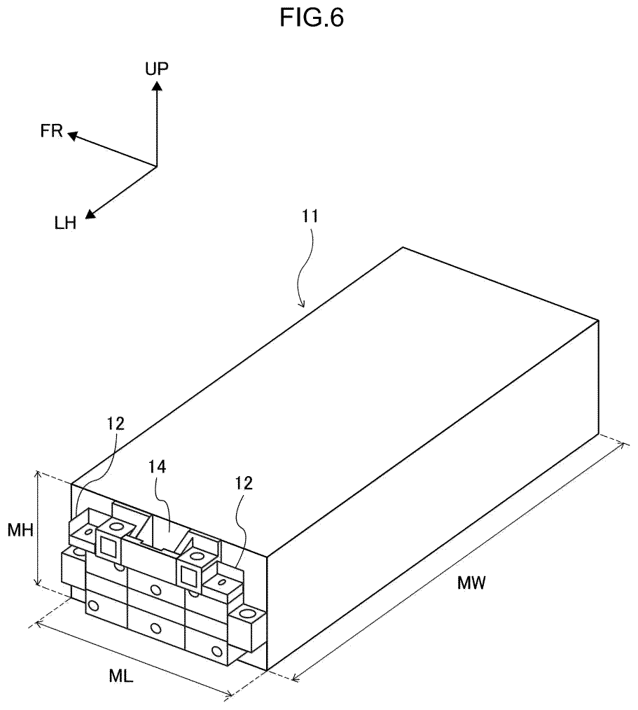

FIG. 6 is a schematic perspective view of a battery module 11. As shown in FIG. 6, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both ends of the battery module 11 in the vehicle width direction. A flexible printed circuit board 21, which will be described later, is connected to the connector 14. Furthermore, bus bars, which are not illustrated in the drawings, are welded to both ends of the battery module 11 in the vehicle width direction.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

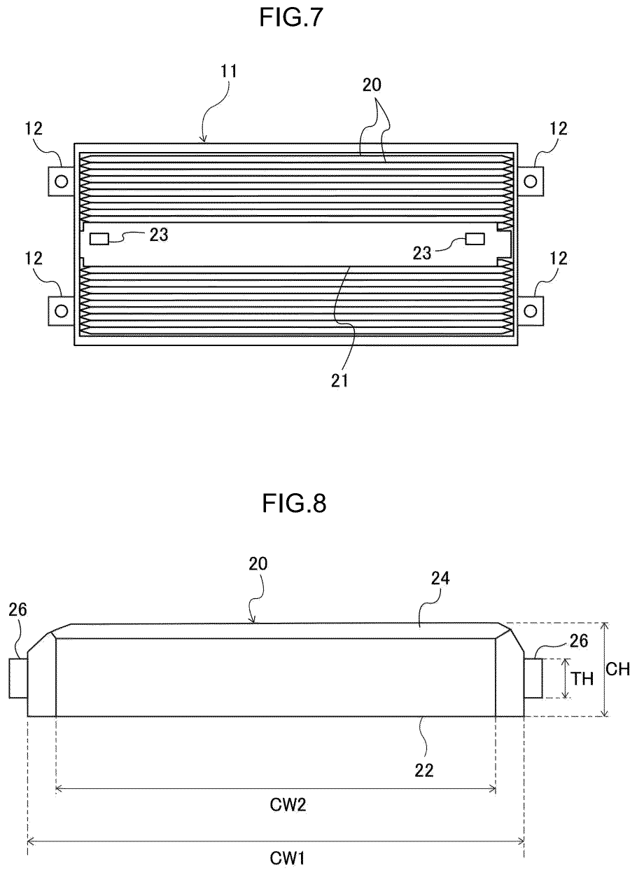

FIG. 7 is a plan view of the battery module 11 in a state in which an upper lid thereof has been removed. As shown in FIG. 7, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end ends of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are disposed at both end portions in the longitudinal direction of the battery module 11 and at the center portion in the longitudinal direction of the battery module 11, respectively.

FIG. 8 is a schematic diagram in which a battery cell 20 that is accommodated in the battery module 11 is viewed from a thickness direction thereof. As shown in FIG. 8, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A battery, comprising an electrode body that includes an electrode and a separator, and an exterior body that is disposed around the electrode body, the battery being restrained by a restraining member,
the electrode body having a bonded portion at which the electrode and the separator are bonded to each other, and a non-bonded portion at which the electrode and the separator are not bonded to each other, and
at least a part of the non-bonded portion of the electrode body matching a portion of the battery restrained by the restraining member.

2. The battery according to claim 1, wherein an entirety of the non-bonded portion of the electrode body matches the portion of the battery restrained by the restraining member.

3. The battery according to claim 1, wherein the non-bonded portion of the electrode body completely matches the portion of the battery restrained by the restraining member.

4. A battery module, comprising the battery according to claim 1.

5. A method of producing the battery according to claim 1, the method comprising:
preparing an electrode body, the electrode body having a bonded portion at which an electrode and a separator are bonded to each other and a non-bonded portion at which the electrode and the separator are not bonded to each other;
disposing an exterior body around the electrode body;
supplying an electrolytic solution to an internal space of the exterior body; and
disposing a restraining member around the exterior body.

6. A method of producing the battery according to claim 1, the method comprising:
preparing an electrode body, the electrode body having a bonded portion at which an electrode and a separator are bonded to each other and a non-bonded portion at which the electrode and the separator are not bonded to each other;
disposing a restraining member around the electrode body;
disposing an exterior body around the electrode body around which the restraining member is disposed; and
supplying an electrolytic solution to an internal space of the exterior body.
